(19) United States
(12) Patent Application Publication
(10) Pub. No.: US 2025/0166291 A1
(43) Pub. Date: May 22, 2025

(54) METHOD AND ELECTRONIC APPARATUS FOR 3D RECONSTRUCTION OF OBJECT USING VIEW SYNTHESIS

(71) Applicant: SAMSUNG ELECTRONICS CO., LTD., Suwon-si (KR)

(72) Inventors: Sunyoung JEON, Suwon-si (KR); Jungmin LEE, Suwon-si (KR); Kwangpyo CHOI, Suwon-si (KR)

(73) Assignee: SAMSUNG ELECTRONICS CO., LTD., Suwon-si (KR)

(21) Appl. No.: 19/030,776

(22) Filed: Jan. 17, 2025

Related U.S. Application Data
(63) Continuation of application No. PCT/KR2023/008106, filed on Jun. 13, 2023.

(30) Foreign Application Priority Data
Sep. 29, 2022 (KR) 10-2022-0124701
Nov. 10, 2022 (KR) 10-2022-0149355

(51) Int. Cl. G06T 15/20; G06T 7/00; G06T 17/00

(52) U.S. Cl. CPC G06T 15/205; G06T 7/0002; G06T 17/00; G06T 2207/10028; G06T 2207/30168

(57) ABSTRACT

A method and electronic apparatus for three-dimensional (3D) reconstruction of an object by using view synthesis are provided. The method includes obtaining source images of a scene including an object, generating a target viewpoint based on a spatial distribution of source viewpoints corresponding to the source images, generating a target image corresponding to the target viewpoint by performing the view synthesis, and generating a 3D model of the object by 3D reconstruction based on the source images and the target image.

### CROSS-REFERENCE TO RELATED APPLICATIONS

This application is a continuation application of International Application No. PCT/KR2023/008106, filed on Jun. 13, 2023, which claims priority to Korean Patent Application No. 10-2022-0124701, filed on Sep. 29, 2022, and Korean Patent Application No. 10-2022-0149355, filed on Nov. 10, 2022, the disclosures of which are incorporated by reference herein in their entireties.

### BACKGROUND

### 1. Field

The disclosure relates to a method and an electronic apparatus for three-dimensional (3D) reconstruction of an object by using view synthesis.

### 2. Description of Related Art

Three-dimensional (3D) reconstruction is a process of implementing a 3D shape of an object. Methods for 3D reconstruction may be largely classified into an active method and a passive method. The active method is a method of reconstructing a 3D profile by a numerical approximation approach with respect to a depth map. The passive method is a method of generating a 3D model based on images or videos captured by a camera.

Representative 3D reconstruction is a process of generating a 3D model of an object by using two-dimensional (2D) images obtained by capturing images of an object. Image processing using a computer may be used for 3D reconstruction. In this case, 2D images used for 3D reconstruction may be 2D images obtained by capturing images of an object through a camera by a user.

### SUMMARY

According to an aspect of the disclosure, there is provided a method for three-dimensional (3D) reconstruction of an object by using view synthesis, the method including: obtaining source images of a scene including an object; generating a target viewpoint based on a spatial distribution of source viewpoints corresponding to the source images; generating a target image corresponding to the target viewpoint by performing the view synthesis; and generating a 3D model of the object by 3D reconstruction based on the source images and the target image.

The generating the target image corresponding to the target viewpoint by performing the view synthesis may include: generating a temporary target image corresponding to the target viewpoint by performing the view synthesis; evaluating a quality of the temporary target image; and generating the target image by reperforming the view synthesis based on a result of the evaluating the quality of the temporary target image.

The generating the target image by reperforming the view synthesis based on the result of the evaluating the quality of the temporary target image may include: adjusting a processing cost of the view synthesis based on the result of the evaluating the quality of the temporary target image; and generating the target image by performing the view synthesis with the adjusted processing cost.

The view synthesis may be based on a deep learning network, and the processing cost of the view synthesis may be adjusted by changing the processing cost of the deep learning network.

The generating the target image corresponding to the target viewpoint by performing the view synthesis may include: generating source depth images from the source images; generating masked source depth images by performing object masking on the source depth images; and generating the target image by performing the view synthesis by using the source images and the masked source depth images.

The generating the target viewpoint based on the spatial distribution of the source viewpoints may include: generating a grid map on a coordinate system; matching the source viewpoints with cells of the grid map based on coordinate values of the source viewpoints on the coordinate system; and generating the target viewpoint to be matched to any one cell among the cells of the grid map that are not matched with the source viewpoints.

The matching the source viewpoints with the cells of the grid map based on the coordinate values of the source viewpoints on the coordinate system may include: based on a coordinate range of a cell of the grid map for two coordinates on the coordinate system including a coordinate value of a source viewpoint about the two coordinates on the coordinate system, matching the source viewpoint to the cell.

The generating the target viewpoint to be matched to any one cell among the cells of the grid map that are not matched with the source viewpoints may include: generating the target viewpoint such that a coordinate value the target viewpoint for two coordinates on the coordinate system is included in a coordinate range of the a cell for the two coordinates on the coordinate system.

The generating the 3D model of the object by the 3D reconstruction based on the source images and the target image may include: generating a temporary 3D model of the object by the 3D reconstruction based on the source images and the target image; evaluating a quality of the temporary 3D model; generating an additional target viewpoint based on a result of the evaluating the quality of the temporary 3D model; generating an additional target image corresponding to the additional target viewpoint by performing the view synthesis; and generating the 3D model of the object by the 3D reconstruction based on the source images, the target image, and the additional target image.

The generating the additional target viewpoint based on the result of the evaluating the quality of the temporary 3D model may include: sensing a defective region of the temporary 3D model; matching at least one cell of the grid map with the defective region; dividing the matched at least one cell; and generating the additional target viewpoint to be matched to the divided at least one cell.

The matching the at least one cell of the grid map with the defective region may include: sensing at least one image used to generate the defective region among the source images and the target image; and matching at least one cell matched with the at least one image to the defective region.

The matching the at least one cell of the grid map to the defective region may include matching at least one cell with a largest size in the defective region to the defective region when the temporary 3D model is two-dimensional (2D)-rendered on the grid map.

According to an aspect of the disclosure, there is provided an electronic apparatus for three-dimensional (3D) reconstruction of an object by using view synthesis including: a memory configured to store one or more instructions; and at least one processor, wherein the one or more instructions, when executed by the at least one processor, cause the electronic apparatus to: obtain source images of a scene including an object, generate a target viewpoint based on a spatial distribution of source viewpoints corresponding to the source images, generate a target image corresponding to the target viewpoint by performing the view synthesis, and generate a 3D model of the object by 3D reconstruction based on the source images and the target image.

The one or more instructions, when executed by the at least one processor, may cause the electronic apparatus to: generate a temporary target image corresponding to the target viewpoint by performing the view synthesis, evaluate a quality of the temporary target image, and generate the target image by reperforming the view synthesis based on a result of the evaluation of the quality of the temporary target image.

The one or more instructions, when executed by the at least one processor, may cause the electronic apparatus to: adjust a processing cost of the view synthesis based on the result of the evaluation of the quality of the temporary target image, and generate the target image by performing the view synthesis with the adjusted processing cost.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating an electronic apparatus according to an embodiment;

FIG. 2 is a diagram schematically illustrating 3D reconstruction of an object by using view synthesis, according to an embodiment;

FIG. 3 is a diagram illustrating modules of an electronic apparatus according to an embodiment;

FIG. 4 is a diagram illustrating a method of generating a target viewpoint based on a spatial distribution of source viewpoints, according to an embodiment;

FIGS. 5 and 6 are diagrams illustrating a method of matching a cell of a grid map with a source viewpoint and a method of generating a target viewpoint, according to embodiments;

FIG. 7 is a diagram illustrating a view synthesizer according to an embodiment;

FIG. 8 is a diagram illustrating a 3D reconstructor and a 3D reconstruction evaluator, according to an embodiment;

FIG. 9 is a diagram illustrating a method of generating an additional target viewpoint based on a result of 3D reconstruction evaluation, according to an embodiment;

FIG. 10 is a diagram illustrating a 3D model generated by a 3D reconstruction method of the related art;

FIG. 11 is a diagram illustrating a 3D model generated by a method for 3D reconstruction of an object by using view synthesis, according to an embodiment; and

FIGS. 12 to 14 are flowcharts illustrating a method for 3D reconstruction of an object by using view synthesis, according to one or more embodiments.

### DETAILED DESCRIPTION

The terms used herein are those general terms currently widely used in the art in consideration of functions in the present disclosure, but the terms may vary according to the intentions of those of ordinary skill in the art, precedents, or new technology in the art. Also, in some cases, there may be terms that are optionally selected by the applicant, and the meanings thereof will be described in detail in the corresponding portions of the disclosure. Thus, the terms used herein should be understood not as simple names but based on the meanings of the terms and the overall description of the present disclosure.

Throughout the disclosure, when something is referred to as “including” an element, one or more other elements may be further included unless otherwise specified. Also, as used herein, the terms such as “units” and “modules” may refer to units that perform at least one function or operation, and the units may be implemented as hardware or software or a combination of hardware and software.

Throughout the disclosure, the singular forms “a”, “an”, and “the” are intended to include the plural forms as well, unless the context clearly indicates otherwise. Likewise, the plural forms are intended to include the singular forms as well, unless the context clearly indicates otherwise. For example, a target image may include target images, and source images may include a source image.

Throughout the disclosure, the expression “at least one of a, b or c” indicates only a, only b, only c, both a and b, both a and c, both b and c, all of a, b, and c, or variations thereof.

In the present disclosure, a viewpoint may refer to a reference point for indicating a camera view. For example, the viewpoint may refer to an origin of a camera coordinate system. The camera coordinate system may be obtained by rotation-transforming and movement-transforming a coordinate system (e.g., a world coordinate system) by using camera extrinsic parameters. That is, when a camera pose is determined, the camera extrinsic parameters may be determined, and the origin of the camera coordinate system may be determined accordingly. Thus, in the present disclosure, the viewpoint may be understood in the same context as the camera pose or the camera extrinsic parameters.

Below, embodiments will be described in detail with reference to the accompanying drawings so that those of ordinary skill in the art may easily implement the embodiments. However, the present disclosure may be embodied in many different forms and should not be construed as being limited to the embodiments set forth herein. Also, in order to clearly describe the present disclosure, portions unrelated to the description will be omitted in the drawings.

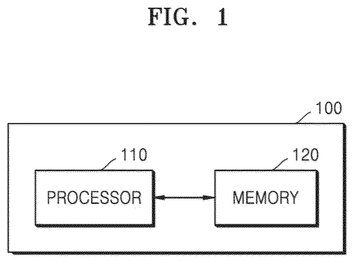

FIG. 1 is a diagram illustrating an electronic apparatus 100 according to an embodiment.

According to an embodiment, the electronic apparatus 100 may include at least one processor 110 and memory 120.

The processor 110 may include a single core, a dual core, a triple core, a quad core, or any multiple core thereof. Also, the processor 110 may include a plurality of processors. For example, the processor 110 may be implemented as a main processor and a sub processor operating in a sleep mode.

Also, the processor 110 may include at least one of a central processing unit (CPU), a graphic processing unit (GPU), and a video processing unit (VPU). Alternatively, according to an embodiment, the processor 110 may be implemented in the form of a system-on-chip (SoC) in which at least one of a CPU, a GPU, and a VPU is integrated. Alternatively, the processor 110 may further include a neural processing unit (NPU).

The memory 120 may store various data, programs, or applications for operating and controlling the electronic apparatus 100. The program stored in the memory 120 may include one or more instructions. The application or program (one or more instructions) stored in the memory 120 may be executed by the processor 110.

According to an embodiment, the electronic apparatus 100 may be configured to perform 3D reconstruction of an object by using view synthesis. The memory 120 may be configured to store one or more instructions for performing 3D reconstruction of an object by using view synthesis, and the processor 110 may be configured to execute the one or more instructions to perform 3D reconstruction of an object by using view synthesis.

Hereinafter, embodiments of a method of performing 3D reconstruction of an object by using view synthesis will be described with reference to the electronic apparatus 100, the processor 110, and the memory 120 illustrated in FIG. 1.

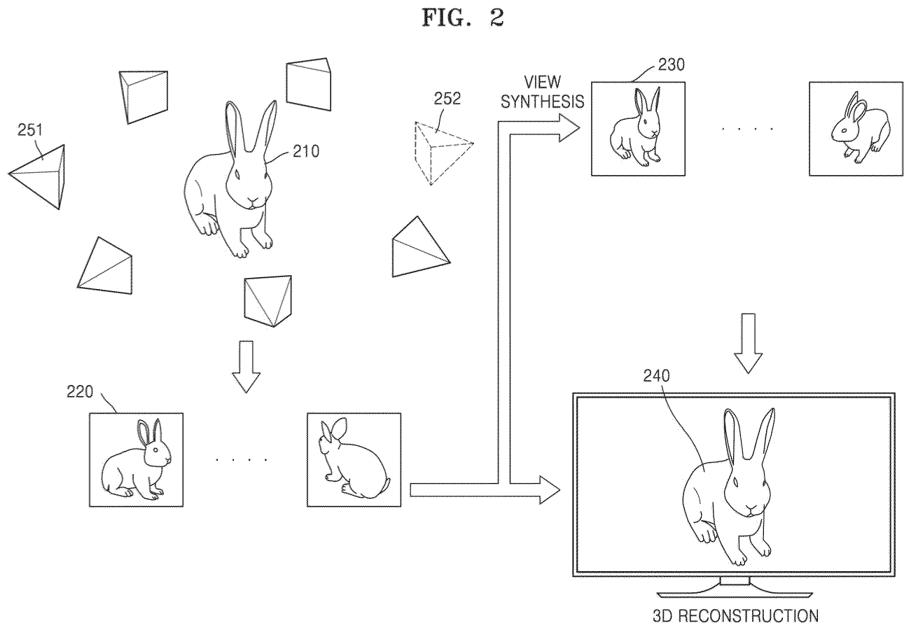

FIG. 2 is a diagram schematically illustrating 3D reconstruction of an object 210 by using view synthesis according to an embodiment.

According to an embodiment, the processor 110 may perform 3D reconstruction of an object 210 to generate a 3D model 240. The processor 110 may use source images 220 and target images 230 for 3D reconstruction.

The object 210 may be any object on which 3D reconstruction is to be performed. For example, the object 210 may be a real object such as a thing, a building, a person, an animal, or a plant.

The processor 110 may receive the source images 220 obtained by capturing a scene including the object 210. The processor 110 may receive the source images 220 from the memory 120 or from an external memory of the electronic apparatus 100.

The source images 220 may be 2D images obtained by capturing a scene including the object 210. The source images 220 may be images captured at different source viewpoints 251. The source images 220 may be images obtained by automatically capturing the object 210 by a camera. The source images 220 may be images obtained by manually capturing the object 210 by the user.

The source images 220 may fail to provide sufficient information for 3D reconstruction. Accordingly, more images may be required for 3D reconstruction. For this purpose, the processor 110 may generate target viewpoints 252 based on a spatial distribution of source viewpoints 251 corresponding to the source images 220. Also, the processor 110 may generate target images 230 corresponding to target viewpoints 252 by performing view synthesis.

The target image 230 may be a synthesized image generated by performing view synthesis based on the source image 220. The target image 230 may be a synthesized image generated by performing view synthesis based on the source image 220 to implement an image obtained by capturing a view at the target viewpoint 252.

The processor 110 may generate a 3D model 240 of the object 210 by 3D reconstruction based on the source images 220 and the target images 230.

By generating, as a target viewpoint, a viewpoint at which an image is not secured and generating a target image corresponding to the target viewpoint, more images may be used for 3D reconstruction and therefore the quality of the 3D model may be improved.

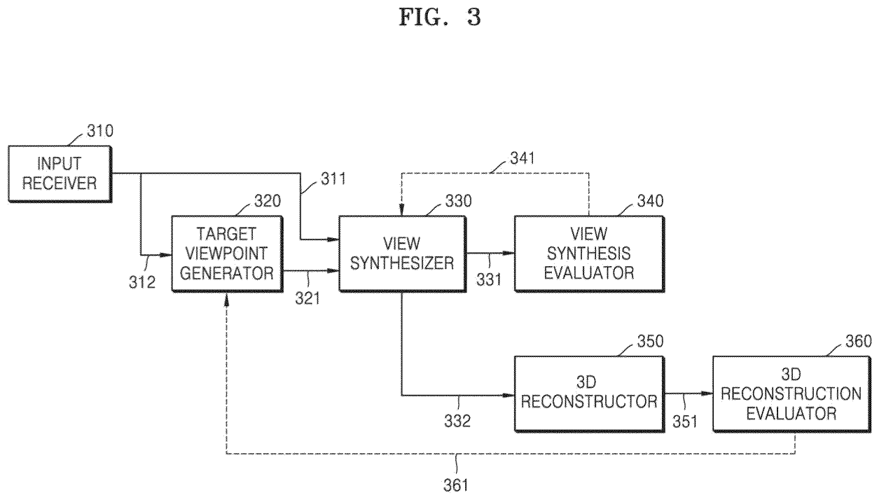

FIG. 3 is a diagram illustrating modules of an electronic apparatus 100 according to an embodiment.

According to an embodiment, the electronic apparatus 100 may include an input receiver 310, a target viewpoint generator 320, a view synthesizer 330, a view synthesis evaluator 340, a 3D reconstructor 350, and a 3D reconstruction evaluator 360.

The modules of FIG. 3 may refer to a unit that processes at least one function or operation executed by the processor 110. The modules of FIG. 3 may be implemented as hardware or software or may be implemented as a combination of hardware and software.

The input receiver 310 may receive source images. The input receiver 310 may obtain camera pose information from the source images. For example, the input receiver 310 may use Structure From Motion (SFM) to obtain the camera pose information. Alternatively, the input receiver 310 may receive source images and camera pose information corresponding to the source images. The camera pose information may include camera extrinsic parameters.

Data received by the input receiver 310 may be loaded from the memory 120 or may be loaded from an external memory of the electronic apparatus 100.

The target viewpoint generator 320 may receive camera pose information 312 from the input receiver 310.

The target viewpoint generator 320 may obtain source viewpoints from the camera pose information 312. The target viewpoint generator 320 may generate target viewpoints based on a spatial distribution of the source viewpoints. The target viewpoint generator 320 may generate the target viewpoints to be different in position from the source viewpoints on the coordinate system (e.g., the world coordinate system).

The view synthesizer 330 may receive the source images and camera pose data 311 from the input receiver 310 and may receive target viewpoints 321 from the target viewpoint generator 320.

The view synthesizer 330 may generate target images corresponding to the target viewpoints by performing view synthesis. The target image may be an inference result of an image obtained by capturing a scene including an object at the target viewpoints.

In an embodiment, the view synthesizer 330 may use a deep learning network for view synthesis. The deep learning network may be a network designed to receive an input of an image and output a synthesized image. In an embodiment, the deep learning network of the view synthesizer 330 may be a network designed to output a synthesized image with an input of an image and camera pose data. In an embodiment, the deep learning network of the view synthesizer 330 may be a network using Neural Radiance Fields for View Synthesis (NeRF). In addition to the networks described above, other networks designed to perform view synthesis may be used by the view synthesizer 330.

The view synthesizer 330 may receive feedback from the view synthesis evaluator 340 and reperform the view synthesis. In a feedback loop, the view synthesis evaluator 340 may generate temporary target images 331 by performing view synthesis and transmit the temporary target images 331 to the view synthesis evaluator 340, and the view synthesis evaluator 340 may evaluate the quality of the temporary target images 331 and transmit an evaluation result 341 to the view synthesizer 330. Upon completion of the feedback, the view synthesizer 330 may generate target images and transmit the target images to the 3D reconstructor 350. The completion requirement of the feedback may include a case where the evaluation result 341 satisfies a preset condition and/or a case where the feedback loop is repeated a preset number of times.

The view synthesis evaluator 340 may evaluate the quality of temporary target images. Various methods may be used to evaluate the quality of the temporary target image. For example, comparison of at least one of a peak signal to noise ratio (PSNR), a visual information fidelity (VIF), a sharpness degree, a blur metric, a blind image quality index (BIQI), and a natural image quality evaluator (NIQE) with a reference value may be used to evaluate the quality of an image. In addition, various methods related to the existing image quality assessment (IQA) may be used to evaluate the quality of the temporary target image.

The view synthesizer 330 may adjust the processing cost of the view synthesis according to the evaluation result of the quality of the temporary target image. The processing cost of the view synthesis may refer to the processing cost of the deep learning network used for the view synthesis. In an embodiment, the processing cost of the view synthesis may be adjusted by changing the processing cost of the deep learning network. In an embodiment, the processing cost of the view synthesis may be adjusted by changing at least one of the size of the deep learning network, the data used in the deep learning network, and the data type used in the deep learning network.

The view synthesizer 330 may maintain the processing cost of the view synthesis or reduce the processing cost of the view synthesis when the evaluation result of the quality of the temporary target image is good. For example, a case where the evaluation result of the quality of the temporary target image is good may be a case where the PSNR of the temporary target image is lower than a reference value. For example, a case where the evaluation result of the quality of the temporary target image is good may be a case where the BIQI of the temporary target image is higher than a reference value.

The view synthesizer 330 may increase the processing cost of the view synthesis when the evaluation result of the quality of the temporary target image is poor. For example, a case where the evaluation result of the quality of the temporary target image is poor may be a case where the VIF of the temporary target image is lower than a reference value. For example, a case where the evaluation result of the quality of the temporary target image is poor may be a case where the NIQE of the temporary target image is lower than a reference value.

By performing the view synthesis by adjusting the processing cost according to the evaluation result of the view synthesis evaluator 340, target images with robust quality may be generated even when the source images are changed. By using the target images with robust quality for 3D reconstruction, the quality of the 3D model may be ensured even when the source images are changed.

The 3D reconstructor 350 may receive source images and target images 332 from the view synthesizer 330. The 3D reconstructor 350 may receive camera pose data corresponding to the source images and/or camera pose data corresponding to the target images from the view synthesizer 330. In this case, the 3D reconstructor 350 may also receive input data from the input receiver 310 rather than the view synthesizer 330.

The 3D reconstructor 350 may generate a 3D model of the object by 3D reconstruction based on the source images and the target images. The 3D reconstructor 350 may use the source images and the target images for 3D reconstruction. Alternatively, the 3D reconstructor 350 may use source depth images and target depth images for 3D reconstruction. In this case, the 3D reconstructor 350 may receive the source depth images and the target depth images instead of the source images and the target images from the view synthesizer 330. Alternatively, the 3D reconstructor 350 may generate source depth images and target depth images from the source images and the target images.

Various methods may be used for 3D reconstruction. For example, 3D reconstruction using a point cloud or 3D reconstruction using a mesh may be used. Also, various methods related to the existing 3D reconstruction may be used for 3D reconstruction.

The 3D reconstruction evaluator 360 may evaluate the 3D model received from the 3D reconstructor 350 and feed back an evaluation result 361 to the target viewpoint generator 320. In a feedback loop, the 3D reconstructor 350 may generate a temporary 3D model 351 by 3D reconstruction and transmit the temporary 3D model 351 to the 3D reconstruction evaluator 360, the 3D reconstruction evaluator 360 may evaluate the quality of the temporary 3D model 351 and transmit an evaluation result 361 to the target viewpoint generator 320, the target viewpoint generator 320 may generate additional viewpoints according to the evaluation result 361, the view synthesizer 330 may generate additional target images corresponding to the additional viewpoints by performing view synthesis, and the 3D reconstructor 350 may perform 3D reconstruction based on the source images, the target images, and the additional target images. Upon completion of the feedback, the 3D reconstructor 350 may output the 3D model. The completion requirement of the feedback may include a case where the evaluation result 361 satisfies a preset condition and/or a case where the feedback loop is repeated a preset number of times.

The 3D reconstruction evaluator 360 may evaluate the quality of the temporary 3D model. Various methods may be used to evaluate the quality of the 3D model. For example, comparison of at least one of the size of a sensed hole, a chamfer distance (CD), and a Hausdorff distance (HD) with a reference value may be used to evaluate the quality of the 3D model. Also, various methods related to the existing 3D image quality assessment (3D IQA) may be used to evaluate the quality of the 3D model.

The target viewpoint generator 320 may generate additional target viewpoints when the evaluation result of the quality of the 3D model is poor. For example, a case where the evaluation result of the quality of the 3D model is poor may be a case where the chamfer distance value of the 3D model is greater than a reference value.

The view synthesizer 330 may generate additional target images corresponding to the additional target viewpoints by performing view synthesis. The source images and/or the target images may be used in view synthesis for generating the additional target images. The 3D reconstructor 350 may output a 3D model by performing 3D reconstruction based on the source images, the target images, and the additional target images.

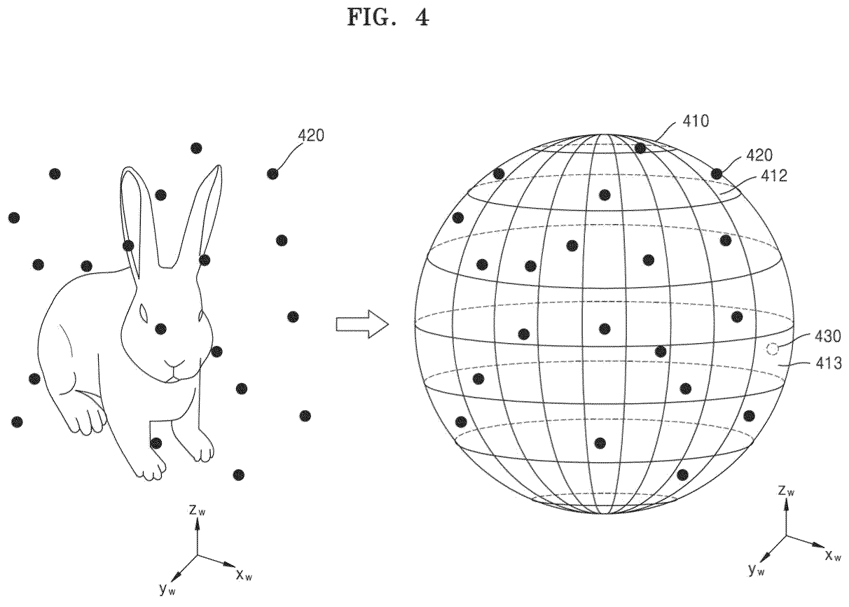

FIG. 4 is a diagram illustrating a method of generating a target viewpoint 430 based on a spatial distribution of source viewpoints 420 according to an embodiment.

An example of a spatial distribution of source viewpoints 420 on the world coordinate system is illustrated on the left side of FIG. 4. The distribution of the source viewpoints 420 may be random, and a grid map 410 may be used to organize the distribution of the source viewpoints 420.

The processor 110 may generate a grid map 410 on the world coordinate system. A grid map 410 in the shape of a sphere is illustrated on the right side of FIG. 4. The shape of the grid map 410 is not limited to a sphere and may be various shapes such as a hemisphere, a cylinder, and a cone. Alternatively, the grid map 410 may include certain cells distributed on the world coordinate system. That is, the grid map 410 may be a set of cells adjacent to each other and/or cells separated from each other.

The processor 110 may match source viewpoints with cells of a grid map based on the coordinate values of the source viewpoints on the world coordinate system. In an embodiment, the processor 110 may match the source viewpoint 420 with the closest cell 412.

The processor 110 may generate target viewpoints 430 to be matched to any one cell 413 among cells of the grid map that are not matched with the source viewpoints. The processor 110 may generate target viewpoints for all cells that are not matched with the source viewpoints in the grid map 410. Alternatively, the processor 110 may calculate a chamfer distance of cells not matched with the source viewpoints with respect to cells matched with the source viewpoints and generate target viewpoints for cells the chamfer distance of which is higher than a reference value. Alternatively, the processor 110 may generate target viewpoints for cells designated in the grid map 410 by the user.

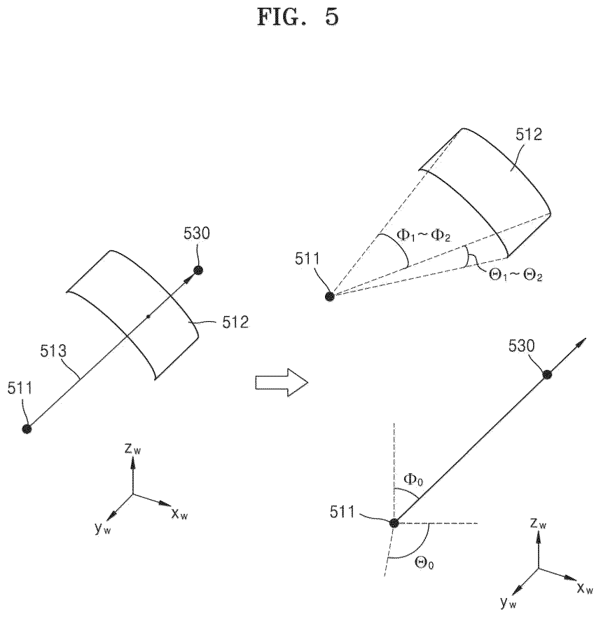

FIG. 5 is a diagram illustrating a method of matching a cell of a grid map with a source viewpoint and a method of generating a target viewpoint according to an embodiment.

First, a method of matching a cell 512 of a grid map with a source viewpoint 530 according to an embodiment will be described.

Referring to the left diagram of FIG. 5, the processor 110 may match the source viewpoint 530 with the cell 512 through which a ray 513 extending from a center point 511 of the grid map toward the source viewpoint 530 passes.

Alternatively, when a coordinate range of a cell of the grid map about two coordinates on the world coordinate system includes a coordinate value of a source viewpoint about the two coordinates on the world coordinate system, the processor 110 may match the cell with the source viewpoint.

The grid map may be represented in a spherical coordinate system on the world coordinate system. The spherical coordinate system may include a first coordinate representing a radial distance, a second coordinate representing an azimuth angle, and a third coordinate representing a polar angle. In an embodiment, when a coordinate range of a cell about the second coordinate and the third coordinate of the spherical coordinate system includes a coordinate value of a source viewpoint about the second coordinate and the third coordinate of the spherical coordinate system, the processor 110 may match the cell with the source viewpoint.

The coordinate range of the second coordinate of the cell 512 illustrated on the right side of FIG. 5 may be Θ₁ to Θ₂, and the coordinate range of the third coordinate thereof may be ϕ₁ to ϕ₂. That is, the azimuth range of the cell 512 may be Θ₁ to Θ₂, and the elevation angle range of the cell 512 may be ϕ₁ to ϕ₂. The coordinate value of the second coordinate of the source viewpoint 530 illustrated on the right side of FIG. 5 may be Θ₀, and the coordinate value of the third coordinate thereof may be ϕ₀. That is, the azimuth value of the source viewpoint 530 may be Θ₀, and the elevation angle value thereof may be ϕ₀. In this case, the processor 110 may match the source viewpoint 530 to the cell 512 when Θ₀ is included in Θ₁ to Θ₂ and ϕ₀ is included in ϕ₁ to ϕ₂.

Next, a method of generating a target viewpoint 530 to be matched with a cell 512 of a grid map that is not matched with a source viewpoint according to an embodiment will be described, using the same drawing.

Referring to the left diagram of FIG. 5, the processor 110 may generate a target viewpoint 530 on a ray 513 extending from a center point 511 of the grid map while passing through the cell 512.

Alternatively, the processor 110 may generate a target viewpoint such that a coordinate value of a target viewpoint about two coordinates on the world coordinate system are included in a coordinate range of a cell about the two coordinates on the world coordinate system. In an embodiment, the processor 110 may generate a target viewpoint such that a coordinate value of a target viewpoint about the second coordinate and the third coordinate of the spherical coordinate system are included in a coordinate range of a cell about the second coordinate and the third coordinate of the spherical coordinate system.

The coordinate range of the second coordinate of the cell 512 illustrated on the right side of FIG. 5 may be Θ₁ to Θ₂, and the coordinate range of the third coordinate thereof may be ϕ₁ to ϕ₂. That is, the azimuth range of the cell 512 may be Θ₁ to Θ₂, and the elevation angle range of the cell 512 may be ϕ₁ to ϕ₂. In this case, the processor 110 may select a coordinate value (Θ₀, ϕ₀) included in the coordinate range of the cell 512 and generate a target viewpoint 530 to have the coordinate value (Θ₀, ϕ₀). In this case, the azimuth value of the target viewpoint 530 may be Θ₀, and the elevation angle value thereof may be ϕ₀.

The processor 110 may determine a radial distance value of the target viewpoint 530 with reference to a radial distance value of the cell 512. Alternatively, the processor 110 may determine a radial distance value of the target viewpoint with reference to a radial distance value of other source viewpoints.

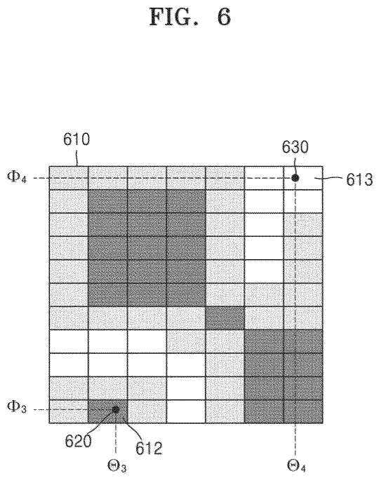

FIG. 6 is a diagram illustrating a method of matching a cell 612 of a grid map with a source viewpoint 620 and a method of generating a target viewpoint 630 according to an embodiment.

First, a method of matching a cell 612 of a grid map with a source viewpoint 620 according to an embodiment will be described.

The processor 110 may generate a grid map 610 on the world coordinate system. The horizontal axis and the vertical axis of the grid map 610 may respectively represent a second coordinate representing an azimuth angle of a spherical coordinate system and a third coordinate representing a polar angle thereof.

The processor 110 may match the cell 612 including a coordinate value (Θ₃, ϕ₃) of the source viewpoint 620 with the source viewpoint 620.

The grid map 610 may be a heat map representing the distribution of source viewpoints. The heat map may represent the distribution of source viewpoints on the world coordinate system. For example, cells matched to the source viewpoints in the heat map may be of a first color, and other cells, that is, cells not matched to the source viewpoints, may be of a second color. For example, cells matched to the source viewpoints in the heat map may be of a first color, cells adjacent to the cells of the first color may be of a second color, and other cells may be of a third color.

The processor 110 may output the grid map 610 through an output interface. The user may understand a spatial distribution of the source viewpoints through the grid map 610.

Next, a method of generating a target viewpoint 630 to be matched with a cell 613 of a grid map that is not matched with a source viewpoint according to an embodiment will be described.

The processor 110 may select a coordinate value (Θ₄, ϕ₄) from the cell 613 of the grid map not matched with the source viewpoint and generate the target viewpoint 630 to have the coordinate value (Θ₄, ϕ₄).

The processor 110 may generate target viewpoints for all cells that are not matched with the source viewpoints in the grid map 610. Alternatively, the processor 110 may generate target viewpoints for all cells with a designated color in the grid map 610. Alternatively, the processor 110 may generate target viewpoints for cells designated in the grid map 610 by the user.

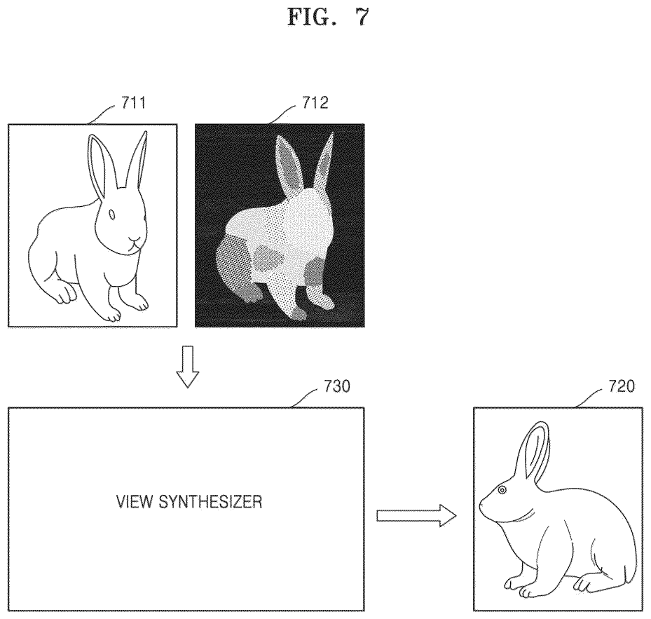

FIG. 7 is a diagram illustrating a view synthesizer 730 according to an embodiment.

In an embodiment, the view synthesizer 730 may generate a target image 720 by performing view synthesis by using source images 711 and masked source depth images 712. For this purpose, the processor 110 may generate a source depth image, which is a depth image of a source image, and perform object masking on the source depth image to generate a masked source depth image.

According to an embodiment, the view synthesizer 730 may include a deep learning network for view synthesis. In an embodiment, the deep learning network may be a network using Neural Radiance Fields for View Synthesis (NeRF).

The source image 711 and/or the masked source depth image 712 may be used for learning of the deep learning network. Also, the source image 711 and/or the masked source depth image 712 may be used for inference of the deep learning network, that is, view synthesis.

By performing the learning and inference of the deep learning network by using the source image 711 and the masked source depth image 712, the target image 720 with improved quality may be obtained.

When the deep learning network using NeRF is used, a depth image may be obtained as the output of the network. In this case, the deep learning network may be used to generate a source depth image. Also, a target image may be obtained as a depth image. In this case, the target image may be used as a depth image for 3D reconstruction. That is, it may be possible to perform an entire process for generating a 3D model without an additional module for generating a depth image.

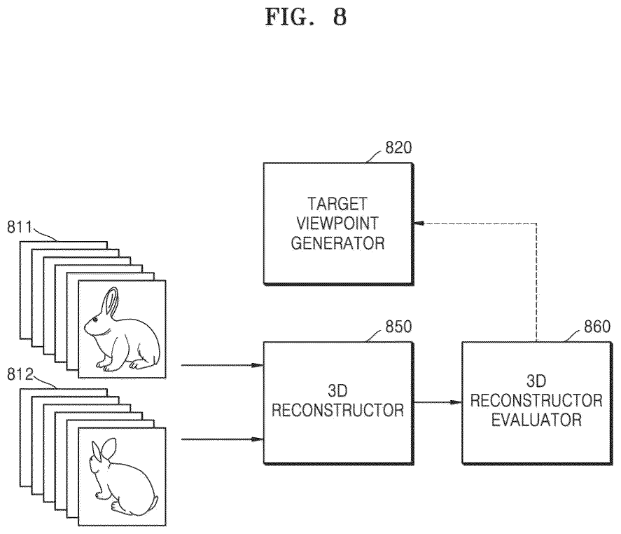

FIG. 8 is a diagram illustrating a 3D reconstructor 850 and a 3D reconstruction evaluator 860 according to an embodiment.

The 3D reconstructor 850 may generate a 3D model of an object by 3D reconstruction based on source images 811 and target images 812. When a depth image is used for 3D reconstruction, the 3D reconstructor 850 may convert the source images 811 and the target images 812 into a depth image. Alternatively, when the target images 812 are generated as a depth image by the view synthesizer, the 3D reconstructor 850 may directly use the target images 812 for 3D reconstruction. Alternatively, when source depth images are generated by the view synthesizer, the 3D reconstructor 850 may receive the source depth images and use the source depth images for 3D reconstruction.

The 3D reconstruction evaluator 860 may evaluate the quality of the 3D model generated by the 3D reconstructor 850. The evaluation result of the 3D reconstruction evaluator 860 may be fed back to a target viewpoint generator 820. The target viewpoint generator 820 may generate additional target viewpoints based on the evaluation result of the 3D reconstruction.

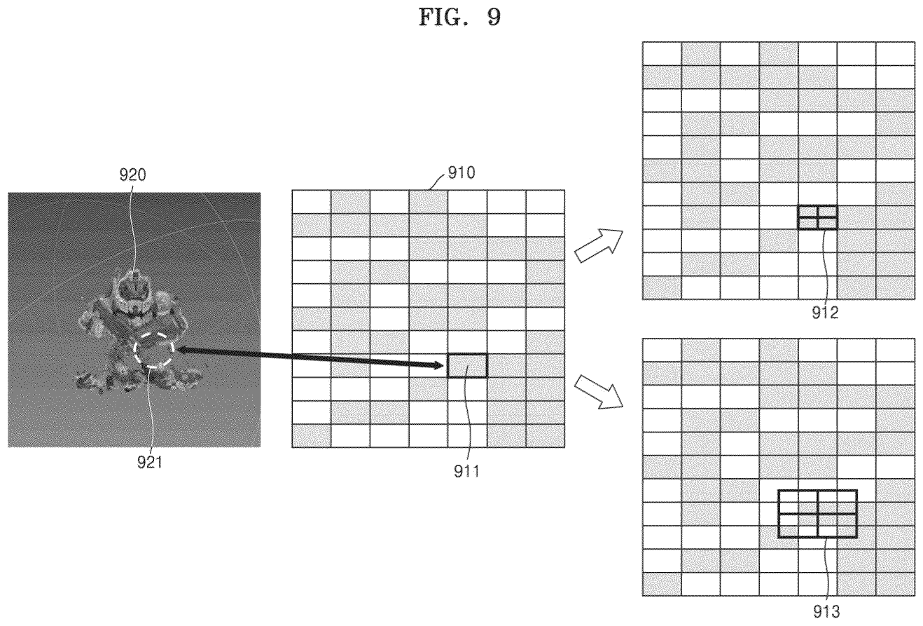

FIG. 9 is a diagram illustrating a method of generating an additional target viewpoint based on an evaluation result of 3D reconstruction according to an embodiment.

The processor 110 may sense a defective region of a 3D model. The defective region may refer to a region in which the 3D model is incompletely reconstructed.

In an embodiment, the processor 110 may sense a defective region based on the evaluation result of the 3D reconstruction. For example, the processor 110 may sense a region in the 3D model where the size of a hole is greater than a reference value as a defective region. A 3D model 920 and a defective region 921 are illustrated on the left side of FIG. 9.

The processor 110 may match at least one cell 911 of a grid map with the defective region 921.

In an embodiment, the processor 110 may sense at least one image used to generate the defective region 921 among the images used for 3D reconstruction, and match at least one cell 911 matched with the at least one image to the defective region 921. For example, when N source images and M target images are used to generate a defective region, the processor 110 may match cells matched to viewpoints of the N source images and the M target images to the defective region.

In an embodiment, when the processor 110 2D-renders the 3D model 920 on a grid map 910, the processor 110 may match at least one cell 911 having the largest size of the defective region 921 with the defective region 921. For example, when a 3D model is 2D-rendered on a grid map to obtain P 2D images, the size of a defective region may be measured in the P 2D images, Q 2D images having the largest size of the defective region among the P 2D images may be selected, and cells matched to the viewpoints of the Q 2D images may be matched with the defective region.

In an embodiment, the processor 110 may divide at least one cell 911 corresponding to the defective region 921. A method of dividing the at least one cell 911 is not limited to the embodiment illustrated in FIG. 9. The processor 110 may generate additional target viewpoints to be matched to at least one divided cells 912.

In an embodiment, the processor 110 may generate additional cells 913 such that at least some region overlaps at least one cell 911 corresponding to the defective region 921. A method of generating the additional cells 913 is not limited to the embodiment illustrated in FIG. 9. The processor 110 may generate additional target viewpoints to be matched to the additional cells 913.

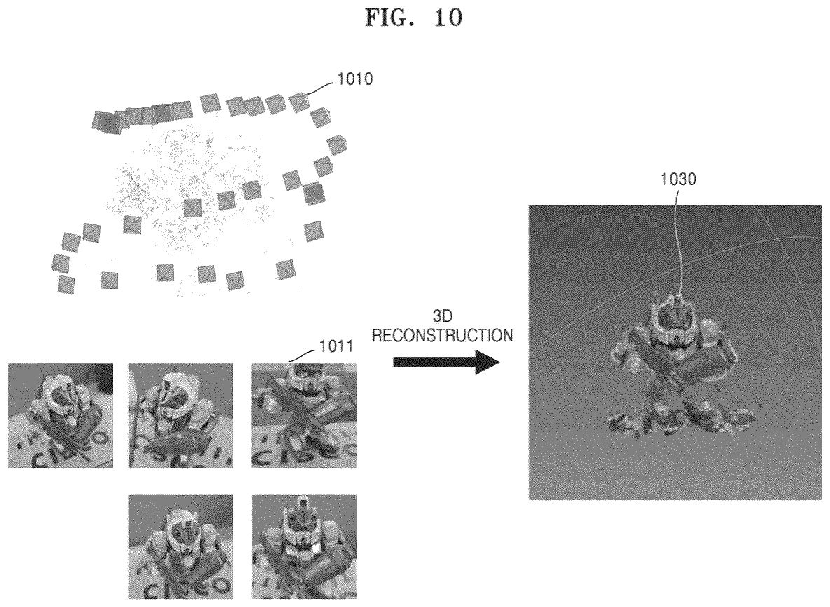

FIG. 10 is a diagram illustrating a 3D model 1030 generated by 3D reconstruction of the related art.

In the 3D reconstruction of the related art, a 3D model 1030 may be generated by performing 3D reconstruction by using only given source images 1011. Insufficient source images 1011 may result in a low-quality 3D model 1030. Also, source viewpoints 1010 determined by the user's camera shooting may fail to provide a sufficient view for 3D reconstruction, thus resulting in a low-quality 3D model 1030.

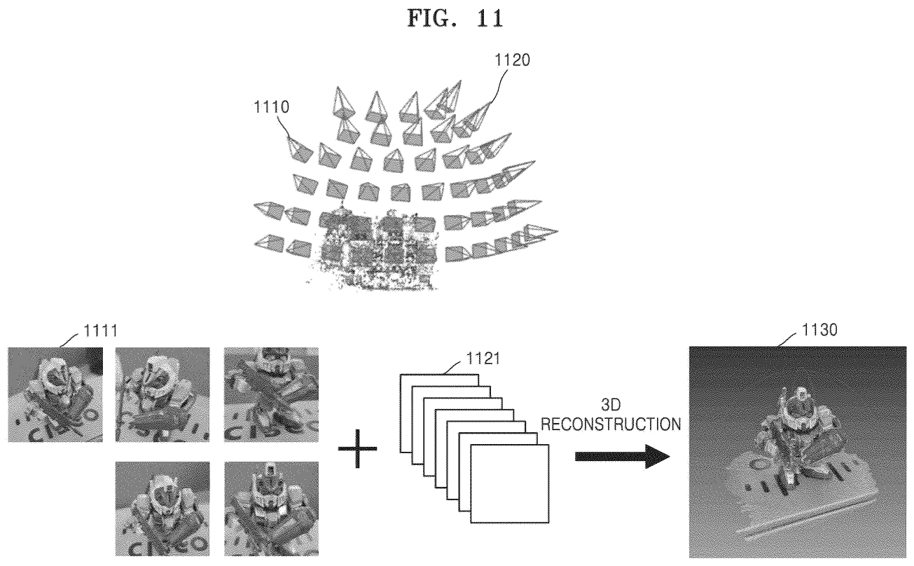

FIG. 11 is a diagram illustrating a 3D model 1130 generated by a method for 3D reconstruction of an object by using view synthesis according to an embodiment.

The method for 3D reconstruction of an object by using view synthesis according to an embodiment may generate target images 1121 by performing view synthesis. Because a sufficient input for 3D reconstruction may be provided by source images 1111 and the target images 1121, a high-quality 3D model 1130 may be generated.

The method for 3D reconstruction of an object by using view synthesis according to an embodiment may generate target viewpoints 1120 based on the spatial distribution of source viewpoints 1110. The target viewpoints 1120 may supplement the image capture at the user's insufficient viewpoint. Also, the target viewpoints 1120 may provide a sufficient view for 3D reconstruction together with the source viewpoints 1110 and thus a high-quality 3D model may be generated.

The method for 3D reconstruction of an object by using view synthesis according to an embodiment may reperform view synthesis according to the evaluation result of view synthesis. By feeding back the evaluation result of view synthesis and reperforming view synthesis, the quality of target images may be improved, thus contributing to improving the quality of the 3D model.

The method for 3D reconstruction of an object by using view synthesis according to an embodiment may generate additional target images according to the evaluation result of 3D reconstruction. By feeding back the evaluation result of 3D reconstruction and generating additional target images, a sufficient input may be provided for 3D reconstruction and a high-quality 3D model may be generated.

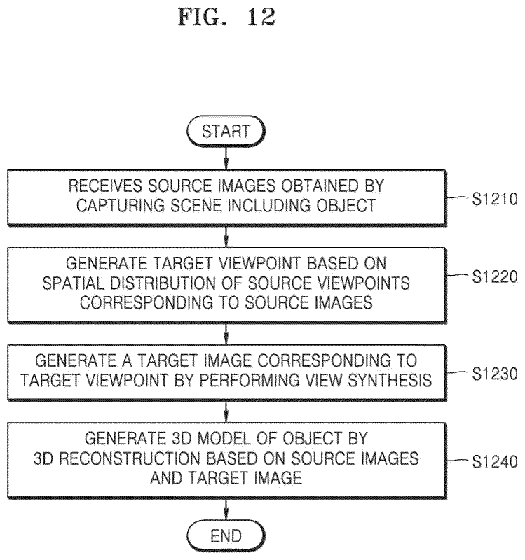

FIG. 12 is a flowchart illustrating 3D reconstruction of an object by using view synthesis according to an embodiment.

In operation S1210, the processor 110 may receive source images obtained by capturing a scene including an object. The processor 110 may obtain camera pose data corresponding to the source images.

In operation S1220, the processor 110 may generate a target viewpoint based on the spatial distribution of source viewpoints corresponding to the source images. The processor 110 may obtain the source viewpoints from the camera pose data. The processor 110 may generate a grid map on the coordinate system (e.g., the world coordinate system) and match the source viewpoints with the grid map. The processor 110 may generate a target viewpoint to be matched with a cell of a grid map that is not matched with the source viewpoints.

In operation S1230, the processor 110 may generate a target image corresponding to the target viewpoint by performing view synthesis.

The processor 110 may use a deep learning network for view synthesis. The deep learning network may infer a target image from the source images and the camera pose data. The source images and/or masked source depth images may be used for learning of the deep learning network.

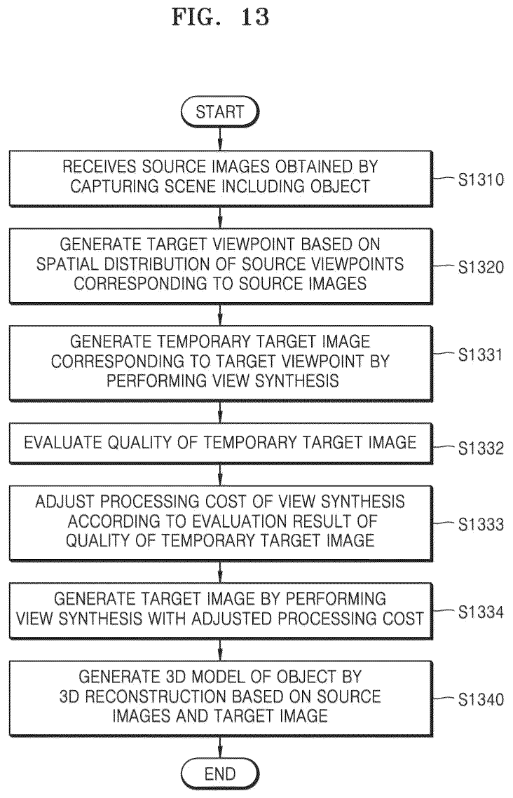

In operation S1240, the processor 110 may generate a 3D model of the object by 3D reconstruction based on the source images and the target image. The processor 110 may generate a high-quality 3D model by using not only the source images but also the target image for 3D reconstruction. FIG. 13 is a flowchart illustrating 3D reconstruction of an object by using view synthesis according to an embodiment.

In operation S1331, the processor 110 may generate a temporary target image corresponding to the target viewpoint by performing view synthesis.

In operation S1332, the processor 110 may evaluate the quality of the temporary target image. Various image quality evaluation methods may be used to evaluate the quality of the temporary target image.

In operation S1333, the processor 110 may adjust the processing cost of the view synthesis according to the evaluation result of the quality of the temporary target image. The processing cost of view synthesis may be changed by adjusting the processing cost of the deep learning network.

In operation S1334, the processor 110 may generate a target image by performing view synthesis with the adjusted processing cost. The processor 110 may increase the processing cost of view synthesis when the evaluation result is poor. By using a higher processing cost for view synthesis, a target image with better quality than the temporary target image may be generated.

Operations S1310, S1320, and S1340 of FIG. 13 may be performed in the same or similar manner as operations S1210, S1220, and S1240 of FIG. 12.

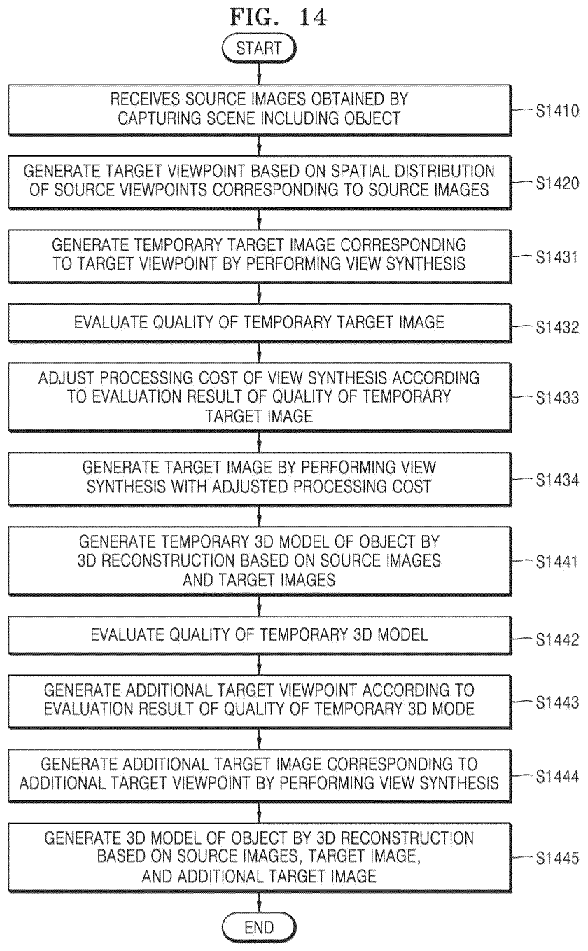

FIG. 14 is a flowchart illustrating 3D reconstruction of an object by using view synthesis according to an embodiment.

In operation S1441, the processor 110 may generate a temporary 3D model of an object by 3D reconstruction based on source images and target images.

In operation S1442, the processor 110 may evaluate the quality of the temporary 3D model. Various 3D image quality evaluation methods may be used to evaluate the quality of the temporary 3D model.

In operation S1443, the processor 110 may generate an additional target viewpoint based on the evaluation result of the quality of the temporary 3D model. When the evaluation result is poor, additional input data may need to be provided for 3D reconstruction. The processor 110 may generate additional target viewpoints for the additional input data. A method of generating the target viewpoint may be used in a method of generating the additional target viewpoints.

In operation S1444, the processor 110 may generate an additional target image corresponding to the additional target viewpoint by performing view synthesis. The processor 110 may generate an additional target image by performing view synthesis by using the source images and/or the target image.

In operation S1445, the processor 110 may generate a 3D model of the object by 3D reconstruction based on the source images, the target image, and the additional target image. By using the additional target image for 3D reconstruction, a 3D model of excellent quality may be generated.

Operations S1410 and S1420 of FIG. 14 may be performed in the same or similar manner as operations S1210 and S1220 of FIG. 12. Also, operations S1431, S1432, S1433, and S1434 of FIG. 14 may be performed in the same or similar manner as operations S1331, S1332, S1333, and S1334 of FIG. 13.

The method for 3D reconstruction of an object by using view synthesis according to an embodiment may be stored in a computer-readable recording medium by being implemented in the form of program commands that may be executed by a computer or processor. The computer-readable recording medium may include program commands, data files, and data structures either alone or in combination. The program commands recorded on the computer-readable recording medium may be those that are especially designed and configured for the present disclosure, or may be those that are known and available to computer programmers of ordinary skill in the art. Examples of the computer-readable recording medium include magnetic media such as hard disks, floppy disks, or magnetic tapes, optical media such as CD-ROMs or DVDs, and magneto-optical media such as floptical disks, and hardware devices such ROMs, RAMs, or flash memories specially configured to store and execute program commands. Examples of the program commands include machine language codes that may be generated by a compiler, and high-level language codes that may be executed by a computer by using an interpreter.

Also, the method for 3D reconstruction of an object by using view synthesis according to the described embodiments may be included and provided in a computer program product. The computer program product may be traded as a product between a seller and a buyer.

The computer program product may include a S/W program and a computer-readable storage medium with a S/W program stored therein. For example, the computer program product may include products in the form of S/W programs (e.g., downloadable apps) electronically distributed through manufacturers of electronic devices or electronic markets (e.g., Google Play Store and App Store). For electronic distribution, at least a portion of the S/W program may be stored in a storage medium or may be temporarily generated. In this case, the storage medium may be a storage medium of a server of a manufacturer, a server of an electronic market, or a relay server for temporarily storing the S/W program.

In a system including a server and a client device, the computer program product may include a storage medium of the server or a storage medium of the client device. Alternatively, when there is a third device (e.g., a smartphone) communicatively connected to the server or the client device, the computer program product may include a storage medium of the third device. Alternatively, the computer program product may include the S/W program itself that is transmitted from the server to the client device or the third device or transmitted from the third device to the client device.

In this case, one of the server, the client device, and the third device may execute the computer program product to perform the method according to the described embodiments. Alternatively, two or more of the server, the client device, and the third device may execute the computer program product to perform the method according to the described embodiments in a distributed manner.

For example, the server (e.g., a cloud server or an artificial intelligence server) may execute the computer program product stored in the server, to control the client device communicatively connected to the server to perform the method according to the described embodiments.

Although embodiments have been described above in detail, the scope of the present disclosure is not limited thereto and various modifications and improvements made by those of ordinary skill in the art by using the basic concept of the present disclosure defined in the following claims are also included in the scope of the present disclosure.

What is claimed is:

1. A method for three-dimensional (3D) reconstruction of an object, the method comprising:
obtaining source images of a scene including an object;
generating a target viewpoint based on a spatial distribution of source viewpoints corresponding to the source images;
generating a target image corresponding to the target viewpoint by performing view synthesis; and
generating a 3D model of the object by 3D reconstruction based on the source images and the target image.

2. The method of claim 1, wherein the generating the target image corresponding to the target viewpoint by performing the view synthesis comprises:
generating a temporary target image corresponding to the target viewpoint by performing the view synthesis;
evaluating a quality of the temporary target image; and
generating the target image by reperforming the view synthesis based on a result of the evaluating the quality of the temporary target image.

3. The method of claim 2, wherein the generating the target image by reperforming the view synthesis based on the result of the evaluating the quality of the temporary target image comprises:
adjusting a processing cost of the view synthesis based on the result of the evaluating the quality of the temporary target image; and
generating the target image by performing the view synthesis with the adjusted processing cost.

4. The method of claim 3, wherein the view synthesis is based on a deep learning network, and
wherein the processing cost of the view synthesis is adjusted by changing the processing cost of the deep learning network.

5. The method of claim 1, wherein the generating the target image corresponding to the target viewpoint by performing the view synthesis comprises:
generating source depth images from the source images;
generating masked source depth images by performing object masking on the source depth images; and
generating the target image by performing the view synthesis by using the source images and the masked source depth images.

6. The method of claim 1, wherein the generating the target viewpoint based on the spatial distribution of the source viewpoints comprises:
generating a grid map on a coordinate system;
matching the source viewpoints with cells of the grid map based on coordinate values of the source viewpoints on the coordinate system; and
generating the target viewpoint to be matched to any one cell among the cells of the grid map that are not matched with the source viewpoints.

7. The method of claim 6, wherein the matching the source viewpoints with the cells of the grid map based on the coordinate values of the source viewpoints on the coordinate system comprises:
based on a coordinate range of a cell of the grid map for two coordinates on the coordinate system including a coordinate value of a source viewpoint about the two coordinates on the coordinate system, matching the source viewpoint to the cell.

8. The method of claim 6, wherein the generating the target viewpoint to be matched to any one cell among the cells of the grid map that are not matched with the source viewpoints comprises:
generating the target viewpoint such that a coordinate value the target viewpoint for two coordinates on the coordinate system is included in a coordinate range of the a cell for the two coordinates on the coordinate system.

9. The method of claim 6, wherein the generating the 3D model of the object by the 3D reconstruction based on the source images and the target image comprises:
generating a temporary 3D model of the object by the 3D reconstruction based on the source images and the target image;
evaluating a quality of the temporary 3D model;
generating an additional target viewpoint based on a result of the evaluating the quality of the temporary 3D model;
generating an additional target image corresponding to the additional target viewpoint by performing the view synthesis; and
generating the 3D model of the object by the 3D reconstruction based on the source images, the target image, and the additional target image.

10. The method of claim 9, wherein the generating the additional target viewpoint based on the quality of the temporary 3D model comprises:
sensing a defective region of the temporary 3D model;
matching at least one cell of the grid map with the defective region;
dividing the matched at least one cell; and
generating the additional target viewpoint to be matched to the divided at least one cell.

11. The method of claim 10, wherein the matching the at least one cell of the grid map with the defective region comprises:
sensing at least one image used to generate the defective region among the source images and the target image; and
matching at least one cell matched with the at least one image to the defective region.

12. The method of claim 10, wherein the matching the at least one cell of the grid map to the defective region comprises matching at least one cell with a largest size in the defective region to the defective region when the temporary 3D model is two-dimensional (2D)-rendered on the grid map.

13. An electronic apparatus for three-dimensional (3D) reconstruction of an object by using view synthesis, the electronic apparatus comprising:
memory configured to store one or more instructions; and
at least one processor configured to execute the one or more instructions,
wherein the one or more instructions, when executed by the at least one processor, cause the electronic apparatus to:
obtain source images of a scene including an object,
generate a target viewpoint based on a spatial distribution of source viewpoints corresponding to the source images,
generate a target image corresponding to the target viewpoint by performing the view synthesis, and
generate a 3D model of the object by 3D reconstruction based on the source images and the target image.

14. The electronic apparatus of claim 13, wherein the one or more instructions, when executed by the at least one processor, cause the electronic apparatus to:
generate a temporary target image corresponding to the target viewpoint by performing the view synthesis,
evaluate a quality of the temporary target image, and
generate the target image by reperforming the view synthesis based on a result of the evaluation of the quality of the temporary target image.

15. The electronic apparatus of claim 14, wherein the one or more instructions, when executed by the at least one processor, cause the electronic apparatus to:
adjust a processing cost of the view synthesis based on the result of the evaluation of the quality of the temporary target image, and
generate the target image by performing the view synthesis with the adjusted processing cost.

16. The electronic apparatus of claim 13, wherein the one or more instructions, when executed by the at least one processor, cause the electronic apparatus to:
generate source depth images from the source images,
generate masked source depth images by performing object masking on the source depth images; and
generate the target image by performing the view synthesis by using the source images and the masked source depth images.

17. The electronic apparatus of claim 13, wherein the one or more instructions, when executed by the at least one processor, cause the electronic apparatus to:
generate a grid map on a coordinate system;
match the source viewpoints with cells of the grid map based on coordinate values of the source viewpoints on the coordinate system; and
generate the target viewpoint to be matched to any one cell among the cells of the grid map that are not matched with the source viewpoints.

18. The electronic apparatus of claim 17, wherein the one or more instructions, when executed by the at least one processor, cause the electronic apparatus to:
generate a temporary 3D model of the object by the 3D reconstruction based on the source images and the target image;
evaluate a quality of the temporary 3D model;
generate an additional target viewpoint based on a result of the evaluating the quality of the temporary 3D model;
generate an additional target image corresponding to the additional target viewpoint by performing the view synthesis; and
generate the 3D model of the object by the 3D reconstruction based on the source images, the target image, and the additional target image.

19. The electronic apparatus of claim 18, wherein the one or more instructions, when executed by the at least one processor, cause the electronic apparatus to:
sense a defective region of the temporary 3D model;
match at least one cell of the grid map with the defective region;
divide the matched at least one cell; and
generate the additional target viewpoint to be matched to the divided at least one cell.

20. The electronic apparatus of claim 19, wherein the one or more instructions, when executed by the at least one processor, cause the electronic apparatus to:
sense at least one image used to generate the defective region among the source images and the target image; and
match at least one cell matched with the at least one image to the defective region.
